(19) United States
(12) Patent Application Publication
(10) Pub. No.: US 2026/0050911 A1
(43) Pub. Date: Feb. 19, 2026

(54) SYSTEMS AND METHODS FOR THE AUTOMATED INTEGRATION OF CRYPTOGRAPHIC PROTOCOLS

(71) Applicant: Rocko Inc., New York, NY (US)

(72) Inventors: Thomas Harrison, New York, NY (US); Vincent DePalma, Bee Cave, TX (US)

(21) Appl. No.: 19/299,249

(22) Filed: Aug. 13, 2025

Related U.S. Application Data
(60) Provisional application No. 63/682,700, filed on Aug. 13, 2024.

(51) Int. Cl. G06Q 20/36

(52) U.S. Cl. CPC G06Q 20/36; G06Q 2220/00

(57) ABSTRACT

The present technology relates to techniques for integrating centralized custodial services and DeFi services. In one aspect of the technology, a platform stores a cryptographic key associated with a user of the platform. The user instructs the platform of a first digital asset to transfer from a centralized custodial service to a DeFi service in exchange for a second digital asset. Based on these instructions, the platform causes the centralized custodial service to transmit the first digital asset to a self-executing computer program of the platform. The platform then transmits the cryptographic key, as well as the instructions, to the self-executing computer program. Upon receipt of the cryptographic key, the instructions, and the first digital asset, the self-executing computer program executes, transmitting the first digital asset to the DeFi service and causing the DeFi service to transmit the second digital asset to the centralized custodial service.

### BACKGROUND

The cryptocurrency and blockchain ecosystem has evolved rapidly over the past decade, with two distinct paradigms emerging for managing and transacting digital assets. Centralized cryptocurrency exchanges and custodial services provide users with familiar, user-friendly interfaces for buying, selling, and storing cryptocurrencies, while offering institutional-grade security and regulatory compliance. These platforms handle the technical complexities of blockchain interactions, allowing users to manage their digital assets through traditional web interfaces similar to online banking.

In parallel, decentralized finance (DeFi) protocols have emerged as programmable financial services built on blockchain networks. These protocols enable users to engage in lending, borrowing, trading, and yield-generating activities without traditional intermediaries. DeFi protocols operate through smart contracts that automatically execute financial transactions based on predetermined rules, offering users direct control over their assets and access to innovative financial products.

### BRIEF DESCRIPTION OF THE DRAWINGS

Detailed descriptions of implementations of the present invention will be described and explained through the use of the accompanying drawings.

FIG. 1 shows a series of n blocks that are cryptographically linked to form a blockchain.

FIG. 2 is a process for transferring a cryptographic currency from a centralized custodian to a decentralized finance protocol through an externally-owned account.

FIG. 3 is a process for transferring a first cryptographic currency as a collateral asset from a centralized custodian to a decentralized finance protocol and for withdrawing a second cryptographic currency as a loan asset from the decentralized finance protocol.

FIG. 4 is a process for transferring a first cryptographic currency as a collateral asset from a centralized custodian to a decentralized finance protocol and for withdrawing a second cryptographic currency as a loan asset from the decentralized finance protocol that is converted into a fiat currency.

FIG. 5 is an improved process for transferring a first cryptographic currency as a collateral asset from a centralized custodian to a decentralized finance protocol and for withdrawing a second cryptographic currency as a loan asset from the decentralized finance protocol that is converted into a fiat currency.

FIG. 6 is a process for detecting when a cryptographic currency is transferred from a centralized custodian and for initiating a transaction with a decentralized finance protocol.

FIG. 7 is another improved process for transferring a first cryptographic currency as a collateral asset from a centralized custodian to a decentralized finance protocol and for withdrawing a second cryptographic currency as a loan asset from the decentralized finance protocol that is converted into a fiat currency with a smart contract.

FIG. 8 is a process for satisfying a cryptographic currency loan asset received from a decentralized finance protocol with a fiat currency.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The current methods for transferring cryptocurrency assets between centralized custodial accounts and decentralized finance (DeFi) protocols involve multiple complex steps across different systems and interfaces. Users typically must first transfer assets from their centralized exchange account to a self-custodial wallet, such as an externally owned account (EOA), before they can interact with DeFi protocols. This process requires users to manage private keys, understand blockchain transaction mechanics, and navigate multiple separate interfaces. Further, the existing workflow involves several technical challenges. For example, users must manually input wallet addresses, confirm transactions across different platforms, and manage the timing of sequential transfers. Each step in the process requires separate authorization and involves transaction fees. Accordingly, users must possess technical knowledge of smart contract interactions and maintain their own security practices for self-custodial wallets, including the secure storage of seed phrases.

These technical barriers limit the broader adoption of DeFi services among users who maintain their cryptocurrency holdings in centralized custodial accounts. The complexity of the current process creates friction that prevents seamless integration between the centralized and decentralized aspects of the cryptocurrency ecosystem. Thus, there exists a general need for systems that can bridge these two paradigms while maintaining security and reducing the technical complexity involved in such interactions.

The present technology relates to techniques for integrating centralized custodial services and DeFi services to reduce the technical complexity of such transactions while maintaining their security. In one aspect of the technology, a platform stores a master private cryptographic key associated with a user of the platform. The user instructs the platform of a first digital asset (e.g., a cryptocurrency) to transfer from a centralized custodial service of the user to a DeFi service (or another blockchain protocol) in exchange for a second digital asset (e.g., a loan). Based on these instructions, the platform causes the centralized custodial service of the user to transmit the first digital asset to a self-executing computer program (e.g., a smart wallet) of the platform. The platform then transmits the master private cryptographic key, as well as the instructions from the user, to the self-executing computer program. Upon receipt of the master private cryptographic key, the instructions, and the first digital asset, the self-executing computer program executes, transmitting the first digital asset to the DeFi service and causing the DeFi service to transmit the second digital asset to the centralized custodial service.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Blockchain Overview

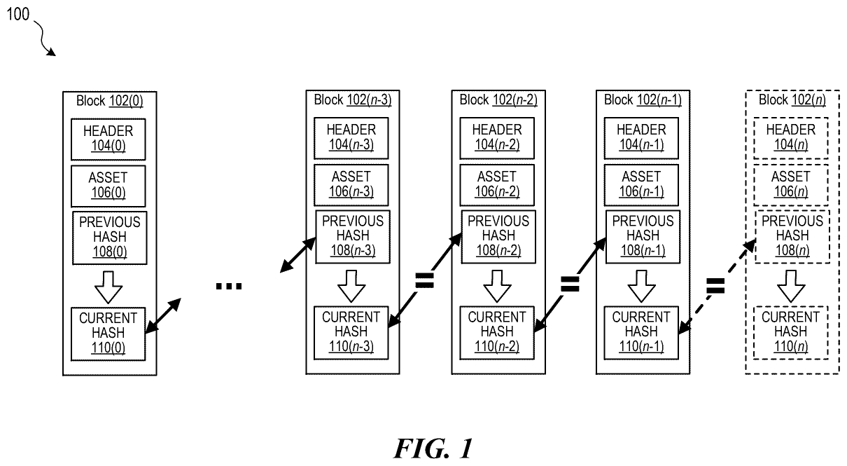

FIG. 1 shows a series of n blocks 102 that are cryptographically linked to form a blockchain 100. Each block 102 stores header information 104, an asset 106, a previous hash value 108, and a current hash value 110. When cryptographically linked, the blocks 102 form an ordered sequence in which each block is uniquely indexed. For clarity, each block 102 is labeled with an index in parentheses that identifies the position of that block 102 in the blockchain 100. For example, the ith block 102 is labeled block 102(i), and it stores similarly indexed header information 104(i), asset 106(i), previous hash value 108(i), and current hash value 110(i). As shown in FIG. 1, the blockchain 100 begins with an origin block 102(0). The number of blocks in the blockchain 100 may be thousands, millions, or more. In FIG. 1, only the origin block 102(0) and the four most recent blocks 102(n−3), 102(n−2), 102(n−1), and 102(n) are shown.

Identical copies of the blockchain 100 may be stored on multiple computing nodes (or simply “nodes”) that cooperate as a peer-to-peer distributed computing network to implement the blockchain 100 as a type of distributed ledger. In this case, the nodes cooperate to add new blocks to the blockchain 100 in a decentralized manner. Said another way, the nodes may cooperate to add new blocks to the blockchain 100 without a central authority or trusted third party.

A consensus protocol may be implemented by the nodes to validate data to be appended to the blockchain 100. Once data is validated by a node, the node may broadcast the validated data to all other nodes, which then update their local copies of the blockchain 100 by appending the validated data to the blockchain 100 as a new block. Validation may be implemented via proof of work (POW), POS, POA, or another type of consensus protocol. Once a block 102 is added to the blockchain 100, it can only be modified via collusion of a majority of the nodes (i.e., a 51 percent attack). Such collusion is highly unlikely-especially for private blockchains-so blockchains are considered secure by design.

Fundamentally, the blockchain 100 may be similar in some respects to those implemented for cryptocurrencies, such as Bitcoin and Ethereum, that process and then store data related to financial transaction. However, the blockchain 100 (and, more specifically, the asset 106 in each block 102) may be able to store any type of data. For example, the asset 106 may include protected health information (“PHI”) or personal identifiable information (“PII”) that are encrypted. In some embodiments the asset 106 is fully unencrypted, while in other embodiments the asset 106 is fully encrypted. Alternatively, the asset 106 may be partially unencrypted and partially encrypted. Advantageously, data that is stored in the blockchain 100 may essentially be immutable and thus can be readily verified during an audit.

While not shown in FIG. 1, the blockchain 100 may have a unique name or identifier that allows it to be uniquely identified from amongst other blockchains that are stored, implemented, or managed by the same computational architecture. Thus, the blockchain 100 may not be the only one accessible to the computational architecture.

FIG. 1 also illustrates how when a new block 102(n) is added to the blockchain 100, it can be cryptographically linked to the previous block 102(n−1). The current hash value 110(n−1) of the previous block 102(n−1) is copied and then stored as the previous hash value 108(n) of the new block 102(n). Thus, the current hash value 110(n−1) equals the previous hash value 108(n). The current hash value 110(n) can then be determined by hashing the header information 104(n), asset 106(n), and previous hash value 108(n) stored in the new block 102(n). For example, the header information 104(n), asset 106(n), and previous hash value 108(n) may be concatenated into a single string that is input into a cryptographic hash function (or simply “hash function”) whose output is stored as the current hash value 110(n). Alternatively, the header information 104(n), asset 106(n), and previous hash value 108(n) may be pair-wise hashed into a Merkle tree whose root node is stored as the current hash value 110(n). Other ways of using the hash function to generate the current hash value 110(n) may be employed without departing from the principles of the present disclosure. Each hash value may be representative of a cryptographically calculated value of fixed length. While the hash values are not guaranteed to be unique across all data, it is usually very hard to duplicate so hash values are valuable in identifying blocks within the blockchain.

The current hash values 110 provide an efficient way to identify changes to any data stored in any block 102, thereby ensuring both the integrity of the data stored in the blockchain 100 and the order of the blocks 102 in the blockchain 100. To appreciate how the current hash values 110 enforce data integrity and block order, consider a change made to one or more of the header information 104(i), asset 106(i), and previous hash value 108(i) of the block 102(i), where i is any integer between 1 and n. The change may be detected by rehashing the block 102(i) and comparing the result with the current hash value 110(i) stored in the block 102(i). Additionally or alternatively, the rehash value may be compared to the previous hash value 108(i+1) that is stored in the subsequent block 102(i+1). Due to the change, the rehash value will not equal the current hash value 110(i) and the previous hash value 108(i+1). These unequal hash values can be used to identify an attempt to alter the block 102(i). Assuming no entity controls a majority of the voting power (i.e., there is no collusion), such attempts to modify data in the blockchain 100 will be rejected due to the consensus protocols described above.

The blockchain 100 may be verified via two steps. First, for each block 102(i), a recomputed hash of the header information 104(i), asset 106(i), and previous hash value 108(i) may be compared to the current hash value 110(i) to ensure that the rehash value equals the current hash value 110(i). This first step authenticates the data stored within each block 102. Second, for each block 102(i), the previous hash value 108(i) may be compared to the current hash value 110(i−1) of the previous block 102(i−1) to ensure that these values are equal. This second step authenticates the order of the blocks 102. Verification of the blockchain 100 may proceed “backwards.” Said another way, the blockchain 100 can be verified by sequentially verifying each block 102 starting from the most recent block 102(n) and ending at the origin block 102(0). Alternatively, verification may proceed “forwards” by sequentially verifying each block 102 starting from the origin block 102(0) and ending with the most recent block 102(n). Validation may occur periodically (e.g., once per hour, day, or week), in response to a predetermined number of new blocks being added to the blockchain 100, or in accordance with a different schedule or triggering event. For the origin block 102(0), the previous hash value 108(0) may be set to an arbitrarily chosen value.

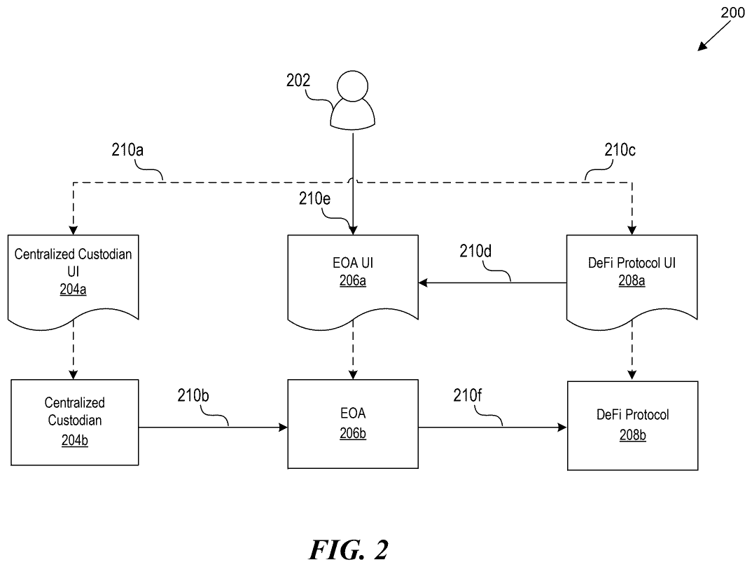

In FIG. 1, each block 102(i) is shown storing its current hash value 110(i). However, it is not necessary for each block 102(i) to store its current hash value 110(i) since it can always be generated by hashing the other data stored in the block 102(i). Nevertheless, storing the current hash value 110(i) in each block 102(i) can greatly speed up retrieval of the blocks 102, and thus access to the asset 106, by using the current hash values 110 as search keys in a database index. For example, each current hash value 110(i) may be represented as a node in a binary search tree (e.g., a B-tree, self-balancing binary search tree, or fractal tree index). Each node may also store the corresponding index i. When a new block 102(n) is added to the blockchain 100, its owner (e.g., as indicated by the owner ID 216 of FIG. 2) may be given the resulting current hash value 110(n) as a confirmation. When the owner wishes to subsequently retrieve the corresponding asset 106(n) from the blockchain 100, the owner may submit a request that contains an indication of the confirmation (e.g., the current hash value 110(n) that serves as a unique identifier). The binary search tree can be searched to quickly find the index n. The block 102(n) may then be directly accessed without having to sequentially search the blocks 102. As an additional check, the receipt may be compared to the current hash value 110(n) of the retrieved block 102(n) to ensure the values match.

### Integration of Centralized and Decentralized Cryptographic Protocols

The process for individuals to transfer cryptocurrency assets into and out of DeFi protocols is a complex and cumbersome process. For example, most individuals and institutions keep their cryptocurrency assets held in centralized custodians using omnibus or individual wallets. To use a DeFi protocol, users need to first transfer funds into the desired smart contract(s) of the DeFi protocol, which requires establishing a connection with the smart contract(s) using an Ethereum (or other blockchain) wallet address and publishing a transaction to the Ethereum (or other blockchain) network that authorizes the desired transaction. If a user then wants to withdraw funds from a DeFi protocol, they have to publish a separate transaction to the blockchain network for the desired transaction using a permissioned wallet. Due to these technical requirements, DeFi users typically interact with DeFi protocols using externally-owned accounts and web interfaces developed for the same DeFi protocols. Furthermore, centralized exchanges (or custodians) are generally unable to directly interact with DeFi protocols meaning that their customers cannot use their account at a centralized exchange to communicate and/or directly transfer funds with a DeFi protocol.

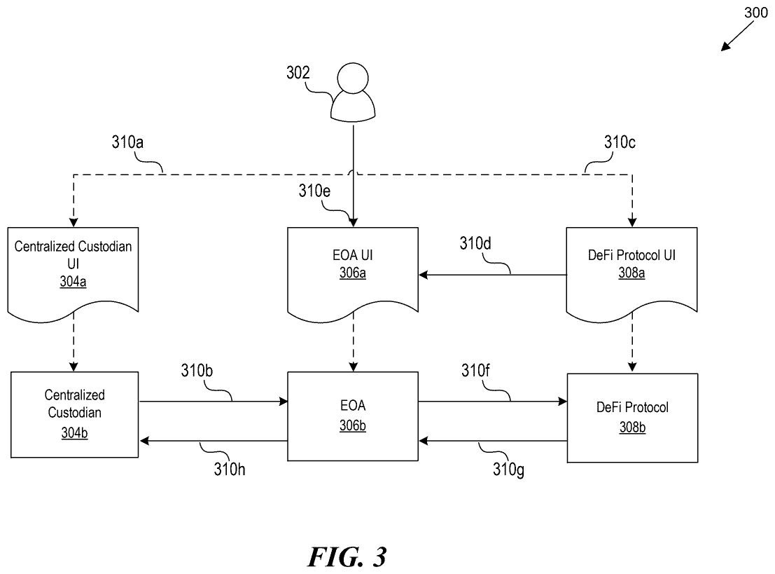

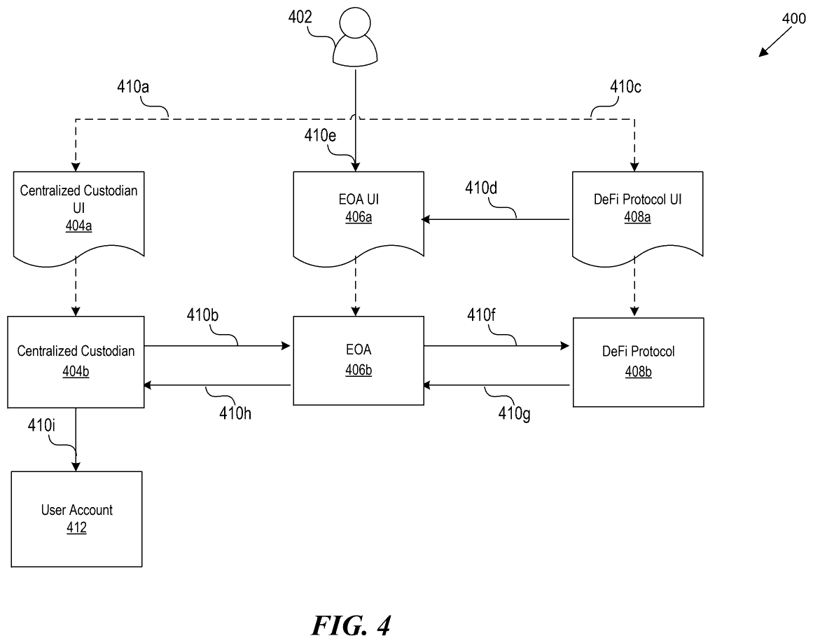

FIG. 2 is a process 200 for transferring a cryptographic currency from a centralized custodian to a decentralized finance protocol through an externally-owned account. As shown in FIG. 2, the process 200 includes a user 202, a centralized custodian user interface (UI) 204a and a centralized custodian 204b, an externally-owned account (EOA) UI 206a and an EOA 206b, a DeFi protocol UI 208a and a DeFi protocol 208b, and steps 210 (as individually denoted by steps 210a-210f). The elements and steps of FIG. 2, and the description thereof, are common to the elements of FIGS. 3 and 4 below.

The centralized custodian UI 204a is a user interface that allows the user 202 to interact with the centralized custodian 204b. The centralized custodian 204b is a third-party service provider (e.g., a financial institution) that securely holds and manages digital assets (such as cryptocurrencies or tokens) on behalf of the user 202. These custodians are typically regulated entities and are responsible for safeguarding private keys, ensuring compliance with legal and regulatory requirements, and providing additional services such as insurance, reporting, and transaction facilitation. The EOA UI 206a is a user interface that allows the user 202 to interact with the EOA 206b. The EOA 206b is a type of account on blockchain networks (such as Ethereum) that is controlled by a private key held by the user 202. EOAs are not governed by code (unlike a smart contract that is governed by code) but by the actions of the private key holder (e.g., the user 202). The DeFi protocol UI 208a is a user interface that allows the user 202 to interact with the DeFi protocol 208b. The DeFi protocol 208b is a set of smart contracts deployed on a blockchain that enables financial services (such as lending, borrowing, trading, or yield farming) without intermediaries. DeFi protocols are open source, permissionless, and operate autonomously according to their programmed rules.

In FIG. 2, the user 202 interacts with three separate user interfaces (the centralized custodian UI 204a, the EOA UI 206a, and the DeFi protocol UI 208a) as well as requiring the user to initiate a funds transfer two separate times from two different interfaces. These requirements make the process of FIG. 2 computationally expensive. More specifically, at step 210a, the user 202 initiates a transfer of a cryptocurrency from the centralized custodian 204b to the EOA 206b by inputting a transfer instruction to the centralized custodian UI 204a. These transfer instructions are input manually, requiring the user 202 to input a wallet address of the EOA 206b of the user 202 into the centralized custodian UI 204a. If at any point in the process the user 202 inputs an incorrect wallet address for the intended recipient, it is possible that the user 202 will permanently lose their funds. In some embodiments, when the user 202 does not have an existing EOA 206b, the user 202 creates the EOA 206b prior to step 210a. In such embodiments, the user creates the EOA 206b with a wallet provider (e.g., as MetaMask) that requires them to install software and store a 12-word seed phrase themselves. Storing a 12-word seed phrase is not a standard or well-known practice for a lay user seeking to transfer a cryptocurrency to a DeFi protocol.

At step 210b, the centralized custodian 204b transmits cryptocurrency assets of the user 202 to the EOA 206b. Once the cryptocurrency assets arrive in EOA 206b, the user 202 must (1) manually confirm the cryptocurrency assets have arrived and (2) find a front-end interface (e.g., DeFi protocol UI 208a) that provides access to the DeFi protocol with which they wish to interact (e.g., the DeFi protocol 208b). Then, at step 210c, the user 202 is required to “connect” with the DeFi protocol UI 208a. Connecting to the DeFi protocol UI 208a includes a blockchain transaction (incurring a financial cost) that provides information and permissions about the centralized custodian (e.g., the centralized custodian 204b) of the user 202 to the DeFi protocol UI 208a. The information provided to the DeFi protocol UI 208a can include instructions for the desired transaction of the user 202 based on the transfer instructions given to the centralized custodian user interface 204a in step 210a.

At step 210d, the DeFi protocol UI 208a sends a transaction request to the EOA UI 206a to transfer the cryptocurrency asset in the EOA 206b to the DeFi protocol 208b. The transaction request can also be referred to as an authorization request or an authentication request. Upon manual acceptance by the user 202 of the transaction request sent to the EOA UI 206a, at step 210f, the EOA 206b publishes a transaction to the blockchain network (e.g., an Ethereum network) that transfers the cryptocurrency assets from the EOA 206b to the DeFi protocol 208b.

FIG. 3 is a process 300 for transferring a first cryptographic currency as a collateral asset from a centralized custodian to a decentralized finance protocol and for withdrawing a second cryptographic currency as a loan asset from the decentralized finance protocol. As shown in FIG. 3, the process 300 includes a user 302, a centralized custodian UI 304a and a centralized custodian 304b, an EOA UI 306a and an EOA 306b, a DeFi protocol UI 308a and a DeFi protocol 308b, and steps 310 (as individually denoted by steps 310a-310h). The process 300, as well as the elements and steps thereof, are the same as that of FIG. 2 above except for the additional steps 310g and 310h that describe the process for withdrawing the second cryptographic currency as a loan asset from the DeFi protocol 308b.

At 310g, to withdraw a cryptocurrency asset from the DeFi protocol 308b, the user 302 interacts with the DeFi protocol UI to transfer the cryptocurrency asset to the EOA 306b. Then, at 310h, the user 302 interacts with the EOA UI 306a to cause the EOA 306b to publish a new transaction to transfer the cryptocurrency asset to the centralized custodian 304b of the user 302. In some embodiments, the first cryptocurrency asset transmitted from the centralized custodian 304b to the DeFi protocol 308b (via steps 310a-310f) is a collateral asset for securing a loan through the DeFi protocol 308b. In such embodiments, the second cryptocurrency asset transmitted from the DeFi protocol 308b to the centralized custodian 304b (via steps 310g and 310h) is a loan asset provided to the user 302 based on the collateral asset.

FIG. 4 is a process 400 for transferring a first cryptographic currency as a collateral asset from a centralized custodian to a decentralized finance protocol and for withdrawing a second cryptographic currency as a loan asset from the decentralized finance protocol that is converted into a fiat currency. As shown in FIG. 4, the process 400 includes a user 402, a centralized custodian UI 404a and a centralized custodian 404b, an EOA UI 406a and an EOA 406b, a DeFi protocol UI 408a and a DeFi protocol 408b, steps 410 (as individually denoted by steps 410a-410i), and the user account 412. The process 400, as well as the elements and steps thereof, are the same as that of FIG. 3 above except for the additional step 410i and the User Account 412 that allow for conversion of the cryptocurrency asset to a fiat currency.

In the case that the user 402 is using the DeFi protocol 408b to borrow funds for a fiat-denominated use case, the user 402 must convert the borrowed funds to a fiat currency and transfer the borrowed funds to an account that enables the fiat-denominated use case. For example, if the user 402 wishes to use the borrowed funds as a loan for a down payment for a real estate purchase, the user must convert the cryptocurrency asset loan into a fiat currency (e.g., USD) and withdraw it to their bank account. In such a case, at step 410i, the user 402 provides instructions to the centralized custodian 404b via the centralized custodian UI 404a to convert the cryptocurrency asset from the DeFi protocol 408b to a fiat currency and then to withdraw the converted fiat currency to the user account 412 (e.g., a bank account of the user 402).

As illustrated above and through the diagrams, the numerous steps involved in transferring funds to and from a DeFi protocol using a centralized account introduce significant complexity, additional costs through form of fees, delays in receiving the funds, and risks of losing funds. For example, users may lose funds if they transfer funds to the wrong address or on the wrong blockchain. Additionally, users may lose funds if they connect their EOA to a compromised interface for a DeFi protocol-a common attack vector in the industry. Precise inputs are required to avoid lost funds, additional transactions, or any other errors that are generally of high consequence given the immutable nature of blockchain networks. Strong technical knowledge of smart contracts and Application Binary Interface (ABI) structure is required in order to interact with DeFi protocols.

### Improved Integration of Centralized and Decentralized Cryptographic Protocols

The present technology simplifies the complex processes and intensive computations traditionally associated with the transfer and management of cryptocurrency assets or other tokenized assets between centralized and decentralized cryptographic protocols. It also reduces the computational expense necessary for transacting with DeFi protocols using cryptocurrency assets held in centralized accounts. Through doing so, it also significantly enhances the security and user experience involved in interacting with DeFi protocols and applications (DApps) while reducing the risk of users losing funds.

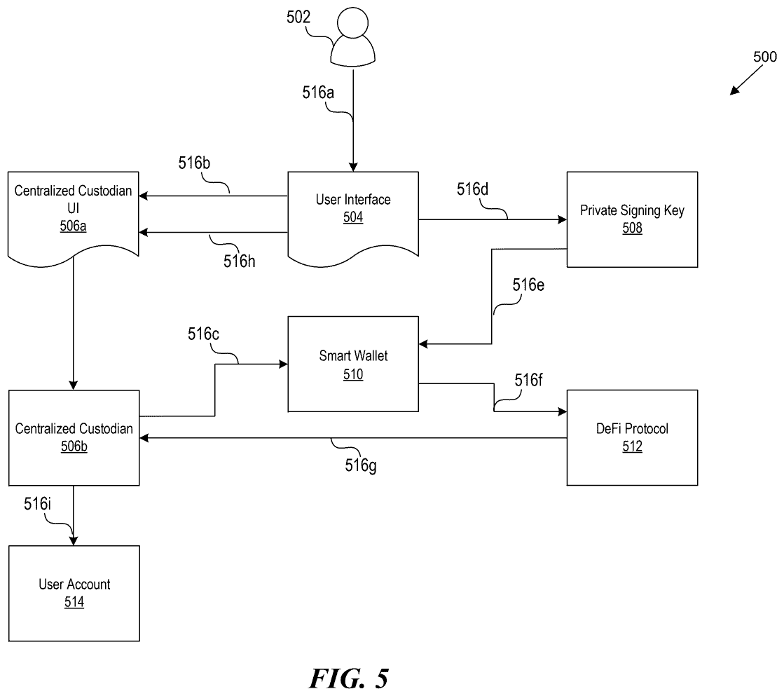

FIG. 5 is an improved process 500 for transferring a first cryptographic currency as a collateral asset from a centralized custodian to a decentralized finance protocol and for withdrawing a second cryptographic currency as a loan asset from the decentralized finance protocol that is converted into a fiat currency. Though described with respect to a single cryptographic currency, the process 500 is capable of transferring multiple cryptographic currency assets and/or other digital assets (e.g., tokenized RWAs) simultaneously. As shown in FIG. 5, the process 500 includes a user 502, a user interface 504 of the present technology, a centralized custodian UI 506a and a centralized custodian 506b, a private signing key 508, a smart wallet 510, a DeFi protocol 512, a user account 514, and steps 516 (as individually denoted by steps 516a-516i).

The user interface 504 is associated with a computational system (also referred to herein as a “system” or a “platform”) of the present technology. The system is operable by a centralized exchange (e.g., Coinbase, Kraken, Binance), a financial institution, or other parties (e.g., a company distinct from centralized exchanges or financial institutions). The functions of process 500 are carried out with input from the user 502 at the user interface 504 and without input from the user 502 at other user interfaces (e.g., the centralized custodian UI 506a). The centralized custodian UI 506a is a user interface that interacts with the user interface 504 to cause a variety of actions by the centralized custodian 506b. The centralized custodian 506b (e.g., the centralized custodian 204b of FIG. 2) is a third-party service provider (e.g., a financial institution) that securely holds and manages digital assets (such as cryptocurrencies, tokens, tokenized RWAs, etc.) on behalf of the user 502. The private signing key 508 is a cryptographic key used to generate digital signatures, proving ownership or authorization over a digital asset or message. In blockchain systems (such as Bitcoin or Ethereum), the private signing key is a randomly generated, secret value that allows the holder to sign transactions, thereby authorizing the transfer of assets or execution of actions on the network. In some embodiments, the private signing key 508 is generated within a secure enclave (not shown), such as a hardware security module (HSM) or a secure execution environment, which provides isolated execution and encrypted storage. Generation of the private signing key 508 within the secure enclave ensures that the key material never leaves the protected environment in plaintext. The platform may interact with the enclave via an API, requesting signing operations or key usage without directly accessing the key material. In some implementations, additional security measures such as multi-factor authentication, access control policies, or quorum-based approval mechanisms may be applied to restrict usage of the private signing key 508, thereby mitigating the risk of unauthorized transactions. In other embodiments, the private signing key 508 may be implemented using a threshold signature scheme (TSS) or multi-party computation (MPC), in which the key is divided into multiple shares distributed across different devices or entities, and signing operations are performed collaboratively without ever reconstructing the full key in plaintext. In yet further embodiments, the private signing key 508 or a single-use private signing key (e.g. session key) is stored by the platform of the present technology (e.g., on a datastore of the platform that is accessible to the user 502 through the user interface 504).

The smart wallet 510 is a self-executing computer program of the platform. In some embodiments, the smart wallet 510 is a blockchain wallet that is implemented as a smart contract, rather than as an EOA, or a smart contract account (e.g. an EIP-4337 smart contract account). In such embodiments, the smart wallet 510 has logic and security rules that are programmable and enforced by the code on the blockchain. In other embodiments, the smart wallet 510 is an EOA (e.g., an EIP-7702-enabled EOA) that includes a delegation signature that allows it to temporarily adopt smart contract functionality and submit an EIP-4337-style Operation. In such embodiments, the delegation signature effectively enables the EOA to behave like a smart contract wallet for the duration of the session. These embodiments are expected to simplify the computational expense needed to achieve the desired outcome as well as reduces network fees by eliminating the need for a separate smart contract wallet deployment and allowing users to operate from a single address. In yet further embodiments, if the transaction were to occur on a separate layer 1 blockchain, such as Solana, the smart wallet 510 may be a keypair, a programmable wallet such as a signer-authority PDA (Program Derived Address) or a custom smart wallet program. In the embodiments where the transaction occurs on Solana, since Solana does not use EOAs or EIP standards, the functionality is replicated through Solana-native mechanisms like PDAs and CPI (cross-program invocation) calls.

The DeFi protocol 512 (e.g., the DeFi protocol 208b of FIG. 2) is a set of smart contracts deployed on a blockchain that enables financial services (such as lending, borrowing, trading, or yield farming) without intermediaries. The user account 514 is an account associated with the user 502. In some embodiments, the user account 514 is a bank account of the user 502.

At step 516a, the user 502 provides transaction instructions to the user interface 504 that specify the transaction amounts, assets, and addresses involved in a desired transaction. For example, if the user 502 seeks to borrow a fiat currency as a loan from a DeFi protocol, the user 502 can input a loan amount, a loan asset(s), a collateral asset(s), a collateral amount, a DeFi protocol(s), and the centralized custodian account and wallet therein to fund the collateral and to receive the loan. These instructions can be input manually to the user interface or via API to the platform's frontend.

In some embodiments, the present technology provides to the user 502, through the user interface 504, an automated method for calculating and displaying the amount of collateral (e.g., a minimum amount or an optimal amount) needed to secure a crypto-backed loan from one or more a DeFi protocols including the DeFi protocol 512. By programmatically determining key loan parameters—such as loan-to-value (LTV) ratios, collateral requirements, and estimated liquidation thresholds—the present technology eliminates the need for the user 502 to perform manual, error-prone calculations that would otherwise require weighting multiple asset-specific LTVs or querying blockchain data manually. The system is configured to determine one or more loan parameters by executing read-only function calls on predetermined smart contract addresses via a blockchain remote procedure call (RPC) interface, thereby retrieving real-time data stored on the distributed ledger without initiating a state-changing transaction. In other embodiments, the system retrieves the information via application programming interfaces (APIs). Because lending protocols may employ differing parameter definitions and calculation methodologies, the system normalizes the retrieved data into a uniform set of values, thereby reducing computational complexity associated with manual reconciliation and facilitating interoperability across protocols.

In other embodiments, the present technology calculates and presents, via the user interface 504, dynamic predefined collateralization options (e.g. average, median, or percentile-based buffers), allowing borrowers to quickly evaluate and select risk-adjusted collateral levels with minimal user input. In some embodiments, this is accomplished by retrieving position data for one or more active borrow positions associated with the lending protocol, such data including at least the borrow amount, borrow asset identifier, collateral amount, and collateral asset identifier. The system may obtain such data by executing read-only function calls on the lending protocol's (e.g., the DeFi protocol 512) smart contracts, such as described above, or by querying an indexed blockchain dataset (e.g., a subgraph). The retrieved collateral values are then mapped to corresponding real-time price data obtained from one or more price oracles or from an API, converted into the denomination of the borrow asset, and used to calculate the ratio of borrow amount to collateral value for each position. When a large number of borrow positions are present, calculating aggregate metrics such as the mean loan-to-value (LTV) ratio or mean overcollateralization amount can be computationally expensive without the present system. In some embodiments, the system mitigates this cost by caching intermediate values (e.g., token prices, collateral factor/max loan-to-value ratio, etc.) and/or parallelizing data retrieval operations, thereby reducing execution time and resource consumption. As a result, the system reduces computational complexity on the part of the user by embedding the relevant logic and data fetching directly into the platform interface, thereby improving usability, accuracy, and transaction efficiency.

In other embodiments, the platform of the present technology is capable of aggregating and analyzing blockchain data (such as borrower health factors, outstanding balances, and historical collateral behavior) from one or more DeFi protocols as described above. This capability is expected to further streamline the borrowing process for the user 502 by abstracting complex backend computations into actionable front-end metrics presented at the user interface 504. In some embodiments, the user 502 can use the user interface 504 to visualize and adjust inputs using intuitive tools such as sliders or predefined selectors rather than conducting iterative blockchain transactions or re-running manual calculations. This reduction in user-side computational burden is expected to not only decrease the likelihood of costly mistakes (such as under collateralization or excessive collateralization) but also to improve capital efficiency and to lower network processing fees by minimizing the number of exploratory on-chain transactions required prior to finalizing the loan.

In yet further embodiments, upon launching the platform of the present technology, the user 502 is prompted to create an account using an authentication mechanism. The authentication mechanisms encompass secure social logins from reputable service providers, email plus one-time password, passkeys, or a combination of username and password. In some embodiments, the authentication mechanism is used to generate (and to access) the private signing key 508 of the user 502.

At step 516b, the user interface transmits the transaction instructions received from the user 502 at step 516a to the centralized custodian UI 506a. In some embodiments, prior to transmitting the transaction instructions to the centralized custodian UI 506a, a connectivity module (not shown) of the platform facilitates a secure link between the platform and the centralized custodian 506b. The connectivity module facilitates the secure link between the platform and the centralized custodian 506b with various secure authentication methods including, but not limited to, Open Authorization (OAuth) tokens and Application Program Interface (API) keys.

As an example of secure authentication with OAuth tokens, the user can initiate the process by requesting, through the user interface 504, to link the centralized custodian 506b. This request can trigger a redirect to an authorization server of the centralized custodian 506b where the user 502 is prompted to log in. As part of this redirection, the platform can include various parameters in the URL including a scope parameter. The scope parameter specifies the level of access and the specific actions that the platform is requesting, such as read and create (write). After logging in, the user 502 is asked to grant necessary permissions, such as access to their account details, including the balances and wallet addresses for various cryptocurrency assets, the ability to initiate transfers of cryptocurrency or fiat assets to and from the centralized custodian 506b, and the ability to convert assets using the centralized custodian 506b. For certain permissions such as transfers, the user 502 can set limits on the amount. Once the user consents, the authorization server of the centralized custodian 506b redirects the user back to platform with an authorization code included as a URL parameter.

Continuing this example, the platform captures the authorization code included as a URL parameter and uses it to request an access token from the centralized custodian 506b. The exchange of the authorization code for an access token can be done securely via server-to-server communication. Once the access token is obtained, the platform can use the access token to make authenticated API calls to the centralized custodian 506b on behalf of the user 502—thereby effectively linking the centralized custodian 506b and the platform. Throughout this process, the use of OAuth ensures that sensitive information, such as user credentials, is not exposed to the platform of the present technology, and that the user 502 retains control over the permissions granted to the platform.

In some embodiments, through linking the centralized custodian 506b and the platform of the present technology, the user 502 is allowed to provide permissions that simplify the desired transaction. These permissions can include, but are not limited to, providing the recipient wallet address, authorizing the transfer of cryptocurrency assets held in the centralized custodian 506b to another address (external or internal), buying, selling, or exchanging assets, and withdrawing assets. For example, if the user 502 wished to receive funds to their account on the centralized custodian 506b, the platform can retrieve the correct wallet address belonging to the user for the desired cryptocurrency asset through the OAuth 2.0 process described above. Specifically, the user 502 would grant permission for the platform to read its wallet address of the centralized custodian 506b for the specific cryptocurrency asset that the user 502 wished to receive or all of the available addresses for the user 502 on the centralized custodian 506b. This scope can be included in the authorization request and once the platform has the access token, the platform can submit a new API request for the wallet address of the specific cryptocurrency asset, or all wallet addresses and parse the response for the specific cryptocurrency asset using the asset's name or ticker. This automated retrieval process for the wallet address or addresses of the user 502 is expected to minimize user input and any potential errors. As another example of customized transactions based on permissions provided by the user 502, the user 502 can enable read permission of their asset balances at the centralized custodian 506b with one permission and enable write permission to send transfers between accounts or externally with another permission. These permissions are communicated to the exchange via an API request (including GET, POST, PUT, and DELETE) along with the user's verification and can simplify a variety of transactions with DeFi protocols.

Once the user 502 has confirmed their transaction instructions in step 516a and/or linked to the centralized custodian 506b, the platform uses the private signing key 508 to deploy the smart wallet 510. In some embodiments, the smart wallet 510 is deployed in accordance with the ERC-4337 specification. In some embodiments, the smart wallet 510 is deployed in accordance with the ERC-4337 specification, which may involve the generation of an account contract and submission of a deployment transaction to a designated entry point contract on the blockchain network. In such embodiments, the platform constructs the deployment transaction locally, signs it using the private signing key 508, and broadcasts it via one or more blockchain remote procedure call (RPC) endpoints. In other embodiments, deployment further includes initializing wallet configuration parameters, such as owner address, spending limits, whitelisted counterparties, and pre-authorized transaction modules. In yet further embodiments, the platform may alternatively deploy the smart wallet 510 through a third-party service by invoking an application programming interface (API) provided by the third-party, which manages wallet creation and deployment on behalf of the platform. The smart wallet 510 has the capability to execute advanced transaction rules and facilitate intermediate interactions with DeFi protocols, thereby opening up a vast array of financial opportunities and services to the user 502.

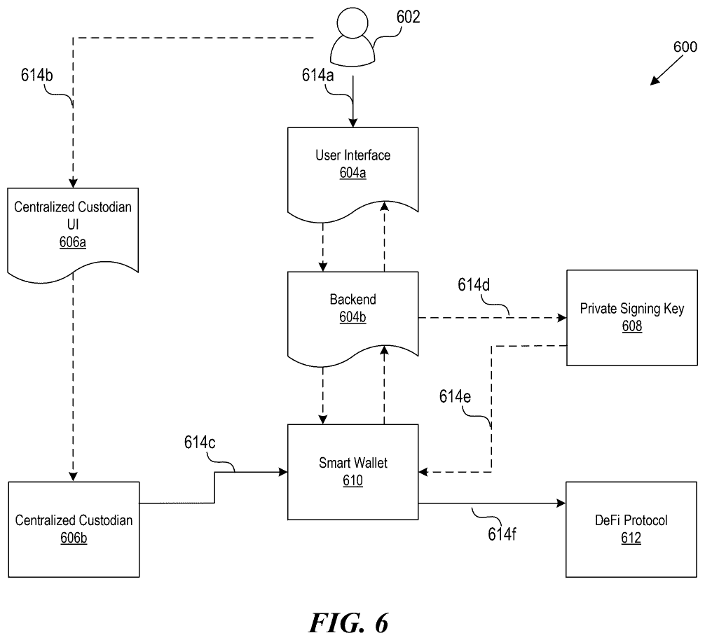

At step 516c, based on the authorization by the user 502 for the transfer of cryptocurrency assets from the centralized custodian 506b, the centralized custodian 50b automatically transmits the cryptocurrency assets to the smart wallet 510. The platform is designed to automatically detect the receipt of funds sent to the smart wallet 510 from the centralized custodian 508b as described below with respect to FIG. 6.

At steps 516d and 516e the transaction instructions provided by the user 502 in step 516a—including the asset(s) to be transferred, the amount of each asset(s), the addresses to send/receive the transfers, and the trigger(s) for the transfers to begin—are transmitted to the smart wallet at or before the time of authorization with the private signing key 508. Then, at step 516f, the smart wallet 510 transmits the cryptocurrency asset to the DeFi protocol 512 in response to authorization with the private signing key 508.

To securely authorize the transaction, in some embodiments, the platform leverages Trusted Execution Environments (TEEs), allowing sensitive computations to occur in hardware-isolated environments. The platform's use of TEE ensures that operations like retrieval of the private signing key 508 and the transaction signing happen in a secure enclave, shielded from the rest of the platform. In such embodiments, a unique session token generated by the platform authenticates the user and is verified within the TEE. If valid, the enclave securely retrieves or derives the private signing key 508 of the user 502, which is then used to sign transactions without exposing the private signing key 508 to the platform. Once signed, the transactions are submitted onchain in accordance with the pre-approved logic of the user 502.

In other embodiments, the smart wallet 510 executes a series of pre-signed transactions (i.e. using session keys), each dictated by predefined rules tailored to the preferences of the user 502 and the transaction requirements. In such embodiments, a unique private key is created that is valid for the specific transaction that was authorized by the user 502 and depends upon a specific condition specified by the user 502 being met. For example, the user 502 can authorize the deposit of funds into the DeFi protocol 512 and the withdrawal of funds from the DeFi protocol 512 dependent upon 1 ETH being deposited into the smart wallet 510. To do so, the user 502 can input the desired transaction into the user interface 504 including the asset(s) to be transferred, the amount of each asset(s), the addresses to send/receive the transfers, and the trigger(s) for the transfers to begin. Then, a call can be initiated to a third-party service to generate a private key that is valid for the specified transaction involving the smart wallet 510. Alternatively, in some embodiments, the platform itself may generate the one-time private key internally, using a secure execution environment or cryptographic module controlled by the platform, without reliance on any third-party service. The single-purpose private key (i.e. session key) can be stored on the a server of the platform until the conditions are met. For example, once the smart wallet 510 has a balance of 1 ETH (which can be verified through a request to query the ETH balance of the smart wallet 510 from an Ethereum node), the session key can be published by the platform and broadcast to the Ethereum network. As such, the smart wallet 510 can transact without requiring the user 502 to be online to sign the transaction at the time it is to be completed. In yet further embodiments, the user can manually provide authorization for the transactions.

In some embodiments, once the cryptocurrency asset is received by the smart wallet 510, the smart wallet 510 is configured to automatically execute on-chain transactions necessary to interact with the DeFi protocol 512 based on the original transaction instructions of the user 502. For example, the permission for the transactions can be automatically provided using a unique token for the session of the user 502 in the platform. This token can authenticate the user 502 to retrieve the private signing key 508 to sign the transaction(s) for the smart wallet 510.

In other embodiments, the transaction occurs on a separate layer 1 blockchain, such as Solana. In such embodiments, a similar process to that described above with respect to process 500 is implemented using a standard or programmable wallet such as a keypair, signer-authority PDA (Program Derived Address) or a custom smart wallet program. Once a cryptocurrency asset is received, the wallet program-pre-authorized by the user-executes transactions to interact with Solana DeFi protocols based on predefined instructions. User authentication and session control can be handled off-chain, and transaction signing can be delegated to a secure enclave or custodial service, with the final signed transactions submitted via the wallet program. Since Solana does not use EOAs or EIP standards, the functionality is replicated through Solana-native mechanisms like PDAs and CPI (cross-program invocation) calls.

In some embodiments, at step 516g, the platform of the present technology facilitates a user-initiated process whereby assets, such as USD Coin (USDC) or other cryptocurrencies, are withdrawn from the DeFi protocol 512 and transferred back to the centralized custodian 506b of the user 502. In some embodiments, the smart wallet 510 withdraws the assets directly from the DeFi protocol 512 directly to the centralized custodian 506b rather than passing the asset through an EOA or the smart wallet 510. The smart wallet 510 can effectuate the withdrawal in the same transaction as the original deposit transaction of steps 516a-516f or can effectuate the withdrawal in a separate transaction. The smart wallet 510 can also allow the user 502 to withdraw funds from the DeFi protocol 512 to multiple accounts or non-custodial Ethereum wallets distinct from the centralized custodian 506b.

At step 516i, the centralized custodian 506b detects a new balance and initiates a conversion transaction. In some embodiments, the centralized custodian 506b detects the new balance and initiates the conversion transaction using integrated API capabilities. In other embodiments, the platform automatically fetches balance data for the centralized custodian and upon confirmation of receipt, automatically sends a request to initiate the conversion. For example, the platform of the present technology can request asset balances or recent transactions via API call to confirm that funds have been received from the DeFi protocol 512 and if they have, the platform can send a second call with conversion instructions. If the user 502 wishes for the assets to be converted into USD, the platform can submit an API call to the centralized custodian 506b for the assets to be converted to USD. This transaction converts the cryptocurrency assets USD based on real-time exchange rates as determined by the centralized custodian 506b to ensure that the user 502 benefits from a fair and accurate conversion value. The current exchange rate can be requested via an API call similar to the process above. In some embodiments, to enhance the security of the conversion transaction, the platform of the present technology incorporates an option for the user 502 to authenticate the conversion transaction with a two-factor authentication (2FA) code, thereby adding an additional layer of protection. In yet further embodiments, the process 500 does not include the conversion transaction. In still further embodiments, the process 500 requests user input to determine whether to initiate the conversion transaction.

At step 516i, the platform is also capable of facilitating an automatic withdrawal of converted funds in the centralized custodian 506b to the user account 514. For example, the platform can submit an API call (as described above) for newly converted USD funds to be withdrawn to a bank account of the user 502 (or another payment method) linked to the centralized custodian 506b.

The process 500 supports myriad DeFi interactions, encompassing but not limited to depositing collateral into lending protocols to take out a loan, engaging in yield-earning opportunities (staking, lending, market making, etc), and participating in decentralized trading exchanges, each interaction executed with precision and in strict adherence to the highest standards of security and efficiency. The process 500 helps bridge the gap between DeFi protocols and traditional financial systems, enabling the practical use of digital assets in broader economic activities. For instance, this novel system allows users to borrow from DeFi protocols and use the proceeds for fiat-denominated use cases such as real estate purchases, large purchases, paying down other debt, and much more.

FIG. 6 is a process 600 for detecting when a specific cryptographic currency or other digital asset is transferred from a centralized custodian and for initiating a transaction with a decentralized finance protocol upon confirmation of receipt. As shown in FIG. 6, the process 600 includes a user 602, a user interface 604a of the present technology and a backend 604b of the present technology, a centralized custodian UI 606a and a centralized custodian 606b, a private signing key 608, a smart wallet 610, a DeFi protocol 612, and steps 614 (as individually denoted by steps 614a-614f). The elements and steps of FIG. 6 are the same as the elements and steps of FIG. 5 except for the backend 604b element. The backend 604b refers to the backend 604b of the platform of the present technology (as opposed to the frontend user interface 604a).

In some embodiments, to detect when the cryptographic currency is transferred from the centralized custodian 606b to the smart wallet 610, the platform receives an indication from a third-party service, such as Etherscan or Solscan, indicating details on the status of the transaction as well as the assets, amounts, and addresses involved. The third-party service can generate the indication based on a query of a transaction hash or other data (e.g., wallet address, block range, transaction amount, transaction type, assets of the transaction, a combination of such data, etc.) used in the transaction. For example, upon the user 602 confirming that the transfer has occurred, the platform can initiate an API call to a third-party provider every 2 minutes requesting details on the balance and transactions of the smart wallet 610. If the API response returned data that validated that the cryptocurrency funds had been received in the amount required for the transaction, the user interface 604a can pass instructions (e.g., the steps 614d and 614e) to the smart wallet 610 for the transaction to initiate. In other embodiments, the platform (e.g., via the platform frontend via backend 604b) queries the balance of the smart wallet 610 or recent transactions involving the address of the smart wallet 610. In such embodiments, the platform queries (e.g., queries a transaction hash, wallet address, etc.) the smart wallet 610 or the recent transactions on a continuing, periodic basis until the platform verifies that the cryptocurrency was transferred to the smart wallet 610. This system allows users to transfer funds from a custodial account to a smart wallet without having to link their account or share any details regarding their account, both reducing computational complexity needed to complete the desired transaction as well as improving security through limiting shared personally identifiable information.

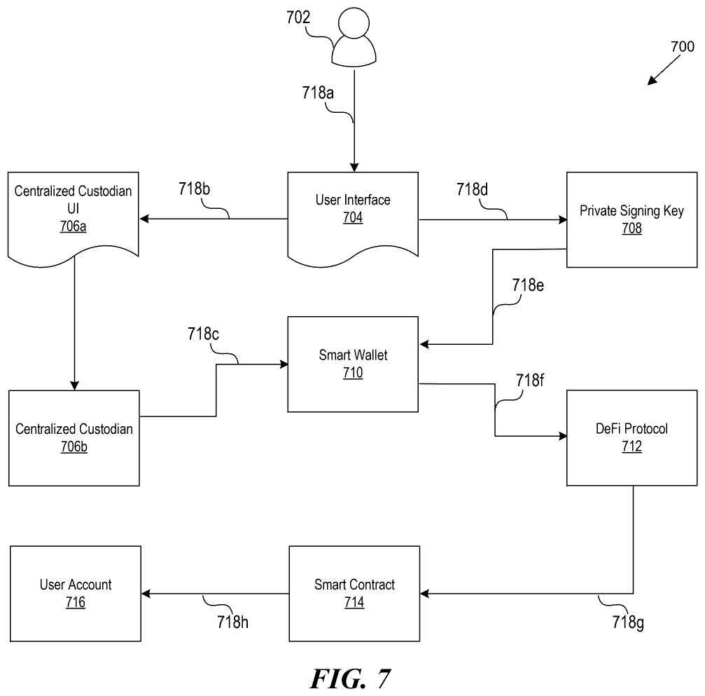

FIG. 7 is another improved process 700 for transferring a first cryptographic currency as a collateral asset from a centralized custodian to a decentralized finance protocol and for withdrawing a second cryptographic currency as a loan asset from the decentralized finance protocol that is converted into a fiat currency with a smart contract. As shown in FIG. 7, the process 700 includes a user 702, a user interface 704 of the present technology, a centralized custodian UI 706a and a centralized custodian 706b, a private signing key 708, a smart wallet 710, a DeFi protocol 712, a smart contract 714, a user account 716, and steps 718 (as individually denoted by steps 718a-718h). The elements and steps of FIG. 7 are the same as the elements and steps of FIG. 5 except for the smart contract 714 and the steps 718g and 718h.

At step 718g, the DeFi protocol 712 transmits the second cryptocurrency asset to the smart contract 714. Then, at step 718h, the smart contract 714 converts the second cryptocurrency asset into a fiat currency and deposits the converted fiat currency into the user account 716 (e.g., a bank account of the user 702). In the embodiments of FIG. 7, the user 702 provides information associated with user account 716 to the user interface 704. In some embodiments, the user 702 provides this information along with the transaction instructions of step 718a. In other embodiments, the user 702 provides this information separately from the transaction instructions of step 718a. The information associated with the user account 716 corresponds to the smart contract 714 that is provided by the platform of the present technology or by a third party. The smart contract 714 is configured to automatically convert the second cryptocurrency asset received from the DeFi protocol 712 to a fiat desired by the user 702. For example, if the second cryptocurrency asset is USDC, the smart contract 714 can “burn” the USDC through an authorized mechanism to receive the USD and then transfer it to the user 702 at the user account 716.

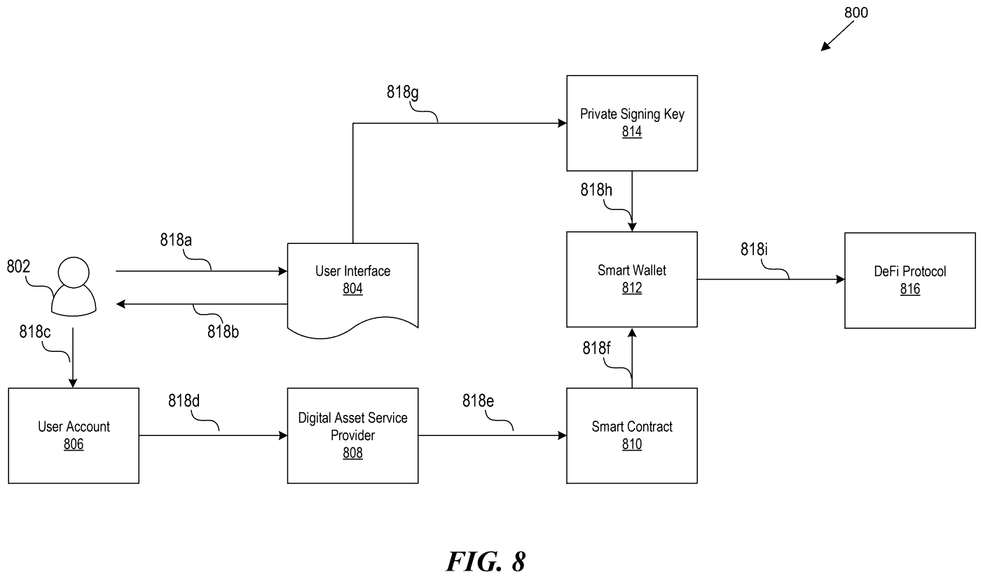

FIG. 8 is a process 800 for satisfying a cryptographic currency loan asset received from a decentralized finance protocol with a fiat currency. In the context of a loan asset, a primary inefficiency in the field today is the difficulty of fully repaying a loan in the exact amount. With some loans from DeFi protocols, interest accrues each second. Thus, the amount borrowers transfer to a DeFi protocol to repay the loan may be insufficient by the time the funds arrive-thereby leaving the loan open and continuing to accrue interest. This is especially prevalent should a borrower need to first transfer funds from a centralized custodian to an EOA before transferring it to the DeFi protocol. Further, it is likely computationally impossible to calculate exactly how much one should transfer from a centralized custodian to repay a loan in the exact amount while accounting for network fees, block times, and interest accrual. Even calculating loose estimates can require significant computational resources. Accordingly, one can easily imagine a scenario in which a borrower must send many transfers of de minimis amounts in an attempt to pay off the final amount of balance plus accrued interest. This computationally expensive process can lead to significant waste in terms of energy usage and network fees.

As shown in FIG. 8, the process 800 includes a user 802, a user interface 804 of the present technology, a user account 806, a digital asset service provider (DASP) 808, a smart contract 810, a smart wallet 812, a private signing key 814, a DeFi protocol 816, and steps 818 (as individually denoted by steps 818a-818i). The user 802, the user interface 804, the user account 806, the smart wallet 812, the private signing key 814, and the DeFi protocol 816 are all similar to those described above with respect to FIGS. 5-7.

The DASP 808 is a platform or entity involved in the minting, exchange, custody, or management of digital assets. For example, the DASP can be a minting provider like OpenSea, a centralized custodian like the centralized custodian described above with respect to FIGS. 2-7, a wallet provider, a fiat< >stablecoin on/off ramp solution provider like Bridge, etc. The DASP 808 is configured to receive an account number and a routing number belonging to a third-party to which the loan amount is owed and to transfer the loan amount from the user account 806 to the third-party. Additionally, the DASP 808 is configured to mint the corresponding amount in a cryptocurrency (e.g., USDC) and transmit the minted cryptocurrency to the smart contract 810.

The smart contract 810 is similar to the smart contracts described above (e.g., the smart contract 714 of FIG. 7). The smart contract 810 is configured to transfer the minted cryptocurrency from the DASP 808 to the smart wallet 812. The smart wallet 812 can then receive authorization from the user, via the user interface 804 and the private signing key 814, to deposit the minted cryptocurrency into the DeFi protocol 816.

At step 818a the user 802 inputs transaction instructions to the user interface 804 of the platform for a transaction that the user 802 whishes to make to satisfy (or reduce liability for) a cryptocurrency-denominated (e.g., USDC-denominated) loan. At step 818b, the platform, through the user interface 804, provides bank transfer instructions (e.g., a bank account number and routing number belonging to a third-party managing the loan) for the user 802 to transfer a fiat currency from the user account 806 to a third-party managing the cryptocurrency-denominated loan. At step 818c, the user 802 inputs the bank transfer instructions to the user account 806. At step 818d, upon completing the transfer, the DASP 808 mints a cryptocurrency (e.g., USDC) with a value equal to that of the fiat currency transferred from the user account 806 to the third-party managing the loan. At step 818e, the DASP 808 transmits the minted cryptocurrency to the smart contract 810. At step 818f, the smart contract 810 transmits the minted cryptocurrency to the smart wallet 812. As described above with respect to FIG. 6, the platform (e.g., via frontend or backend) can detect when cryptocurrency of a particular transaction is received by the smart wallet 812. Upon detecting that the minted cryptocurrency was received by the smart wallet 812, at steps 818g and 818h, the user interface 804 transmits the transaction instructions (received at step 818a) along with the private signing key 814 to the smart wallet 812. With the minted cryptocurrency, the transaction instructions, and the private signing key814, the smart wallet 812 automatically executes its pre-programmed action to transmit the minted cryptocurrency to the DeFi protocol 816.

In some embodiments, the actions of FIG. 8 are accomplished with differing steps and elements. For example, the user 802 can deposit fiat money in a centralized custodian and use API credentials to automate the conversion and transfer of funds. As another example, the USDC (or other cryptographic asset) can be transferred directly from the smart contract 810 to the DeFi protocol 816. As a yet further example, the user 802 can pre-authorize the on-chain transactions using session keys as described above with respect to FIG. 5.

In some embodiments, the user 802 initially supplies a small excess of funds in addition to the loan repayment amount, at the time of the transaction, to third-party managing the loan and, through steps 818a-818f, to the smart wallet 812. For example, if the user 802 has initiated the repay flow and has a 101 USDC balance on their loan and the current interest rate is 10%, a 1 USDC buffer could be added to the amount for full repayment. The user 802 can then transfer 102 USDC to the smart wallet 812 and, once the funds are received, the smart wallet 812 can transfer the up-to-date amount allotted to the DeFi protocol 816 (e.g., a new loan balance of 101.01 USDC that accrued during the transaction time of steps 818a-818f). Thus, the platform ensures that the amount transferred to the DeFi protocol 816 is the exact amount needed to repay the loan in full while accounting for any interest that accrues during the latest block. Excess USDC that remains in the smart wallet 812 is returned to a centralized custodian (e.g., the centralized custodian 506b of FIG. 5) of the user 802 along with the collateral from the loan.

### Integration of Centralized and Decentralized Cryptographic Protocols

The descriptions of FIGS. 5-8 above primarily discuss transferring cryptocurrency assets into and out of DeFi protocols in the context of DeFi lending protocols. Specifically, the embodiments of FIGS. 5-8 above detail improved processes for transferring cryptocurrency assets into and out of DeFi protocols. For example, a user desiring to leverage their cryptocurrency holdings can utilize the platform of the present technology to interact with a DeFi lending protocol. Through the user interface, the user can seamlessly transfer cryptocurrency assets from their centralized custodian to a smart wallet. The platform's automated processes then engage with the lending protocol, allowing the user to deposit their assets as collateral. In return, the user receives a loan in a stablecoin or other cryptocurrency, as per the terms of the lending protocol. The loan amount is automatically transferred back to the user's centralized custodian or designated recipient address, providing the user with liquidity while their assets remain securely locked in the protocol as collateral. This example underscores the system's capability to interface with DeFi lending protocols, simplifying the process of asset collateralization and loan receipt, thereby enhancing user participation and confidence in DeFi lending services. It increases the accessibility to credit using cryptocurrencies, NFTs, tokenized real-world assets, and other digital assets and ability for the funds to be used for dollar, or other fiat-denominated use cases.

Though FIGS. 5-8 primarily discuss transferring cryptocurrency assets into and out of DeFi protocols in the context of DeFi lending protocols, the present technology is not so limited. For example, protocols other than DeFi protocols like yield earning protocols, decentralized exchange protocols, self-custodial wallets, and other blockchain protocols can benefit from the present technology.

In the context of yield-earning protocols, the platform offers a robust solution for users seeking to maximize the return on their cryptocurrency assets. For example, a user can utilize the system to deposit assets into a yield-earning protocol that offers interest or rewards based on staking or liquidity provision. The user initiates the transaction through the platform, which securely transfers the specified assets from the user's centralized custodian to their smart wallet. The platform then interacts with the yield-earning protocol, depositing the assets into the appropriate contract. The assets are utilized within the protocol to generate returns, which are then automatically deposited back into the user's smart wallet. The user can choose to reinvest these returns, withdraw them back to their centralized custodian, or engage in further DeFi activities, all facilitated seamlessly through the system. This example illustrates the system's effectiveness in simplifying the process of engaging with yield-earning protocols, thereby opening up avenues for passive income generation in the DeFi space.

The platform is also adeptly designed to interact with decentralized exchange (DEX) protocols, enabling users to conduct secure and efficient asset trades in a decentralized manner. Consider a user seeking to exchange one cryptocurrency for another to capitalize on market opportunities or diversify their portfolio. Through the platform, the user can authorize the transfer of assets from their centralized custodian to their smart wallet. The platform, leveraging its automated and secure protocols, interacts with a chosen DEX, executing the trade as per the user's instructions. The received assets, post-trade, are then securely held in the smart wallet or transferred back to the user's centralized custodian as per their preference. This use case exemplifies the system's capability to streamline the trading process on DEXs, mitigating the complexities and security concerns commonly associated with decentralized trading.

Additionally, the present technology is capable of interfacing with self-custodial wallets rather than centralized custodians. In such embodiments, the process as described above with respect to FIGS. 5-8 is generally the same except that the user transfers the funds to the smart wallet from a self-custodial wallet. This adds a security benefit in that the user is not required to connect their wallet to any interface, thereby reducing the risk of loss of funds.

Beyond specific DeFi services, the present technology can support a wide array of interactions with various blockchain protocols. Whether it involves participating in governance systems, engaging with NFT marketplaces, or interacting with emerging blockchain-based applications, the system provides a secure and efficient gateway. Users can leverage the system's robust framework to connect their centralized custodians with these diverse protocols, partake in transactions or contractual agreements, and have the resultant assets or tokens securely managed through their smart wallet. This flexible and secure interaction capability illustrates the system's versatility and adaptability, ensuring users can confidently explore and engage with the evolving landscape of blockchain-based services and applications.

### Computer System

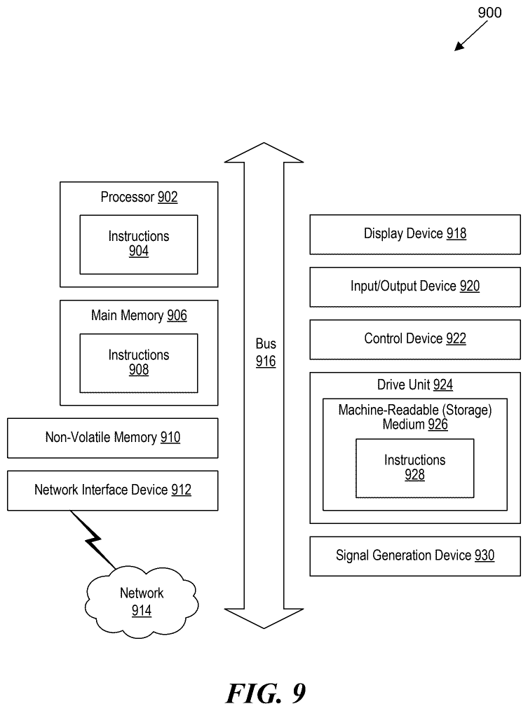

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions when executed by at least one data processor of a system, cause the system to:
receive a cryptographic key that is associated with a user of the system;
receive instructions indicating a first digital asset of a first platform, a second platform of a blockchain protocol, and a second digital asset,
wherein the instructions indicate each of the first digital asset of the first platform, the second platform of the blockchain protocol, and the second digital asset with a different cryptographic address;
wherein the first platform is associated with the user; and
wherein the first digital asset and the second digital asset are stored on a blockchain;
cause, via an Application Program Interface (API) call to the first platform, the first platform to transmit the first digital asset to a self-executing computer program of the system that is stored on the blockchain;
in response to receiving the first digital asset at the self-executing computer program, transmit the cryptographic key and the instructions to the self-executing computer program;
execute the self-executing computer program,
wherein the self-executing computer program is configured to execute in response to the self-executing computer program receiving (i) the cryptographic key, (ii) the instructions, and (iii) the first digital asset;
wherein execution of the self-executing computer program—
transmits the first digital asset to the second platform of the blockchain protocol; and
causes the second platform of the blockchain protocol to transmit the second digital asset to the first platform.

2. The non-transitory, computer-readable storage medium of claim 1, wherein the instructions when executed by the at least one data processor of the system, cause the system to:
execute the self-executing computer program,
wherein the self-executing computer program is a smart contract associated with a smart wallet or a delegation signature associated with an externally-owned account.

3. The non-transitory, computer-readable storage medium of claim 1, wherein the instructions when executed by the at least one data processor of the system, cause the system to:
receive the instructions indicating the first digital asset of the first platform, the second platform of the blockchain protocol, the second digital asset, and a user account; and
execute the self-executing computer program,
wherein execution of the self-executing computer program-transmits the first digital asset to the second platform of the blockchain protocol; and
causes the second platform of the blockchain protocol to transmit the second digital asset to the user account.

4. The non-transitory, computer-readable storage medium of claim 1, wherein the first platform of the blockchain protocol further comprises:
a centralized custodian account; or
a self-custodial wallet.

5. The non-transitory, computer-readable storage medium of claim 1, wherein the second platform of the blockchain protocol further comprises:
a decentralized finance protocol;
a yield earning protocol; or
a decentralized exchange protocol.

6. The non-transitory, computer-readable storage medium of claim 1, wherein the instructions when executed by the at least one data processor of the system, cause the system to:
prior to causing the first platform to transmit the first digital asset to the self-executing computer program, request an access token from the first platform; and
cause, via the access token and the API call to the first platform, the first platform to transmit the first digital asset to the self-executing computer program of the system that is stored on the blockchain.

7. The non-transitory, computer-readable storage medium of claim 1, wherein the instructions when executed by the at least one data processor of the system, cause the system to:
detect, based on a query of data associated with the transmission of the first digital asset to the self-executing computer program, that the self-executing computer program has received the first digital asset; and
in response to detecting that the self-executing computer program has received the first digital asset, transmit the cryptographic key and the instructions to the self-executing computer program.

8. The non-transitory, computer-readable storage medium of claim 1, wherein the instructions when executed by the at least one data processor of the system, cause the system to:
detect that the user is a new user; and
in response to detecting that the new user, generate the cryptographic key that is associated with the new user.

9. A system comprising:
at least one hardware processor; and
at least one non-transitory memory storing instructions, which, when executed by the at least one hardware processor, cause the system to:
receive a cryptographic key that is associated with a user of the system;
receive instructions indicating a first digital asset of a first platform and a second platform of a blockchain protocol,
wherein the instructions indicate each of the first digital asset of the first platform and the second platform of the blockchain protocol with a different cryptographic address;
wherein the first platform is associated with the user; and
wherein the first digital asset is stored on a blockchain;
cause, via an Application Program Interface (API) call to the first platform, the first platform to transmit the first digital asset to a self-executing computer program of the system that is stored on the blockchain;
in response to receiving the first digital asset at the self-executing computer program, transmit the cryptographic key and the instructions to the self-executing computer program;
execute the self-executing computer program,
wherein the self-executing computer program is configured to execute in response to the self-executing computer program receiving (i) the cryptographic key, (ii) the instructions, and (iii) the first digital asset;
wherein execution of the self-executing computer program transmits the first digital asset to the second platform of the blockchain protocol.

10. The system of claim 9, wherein the instructions when executed by the at least one hardware processor of the system, cause the system to:
receive instructions indicating a second digital asset,
wherein the instructions indicate the second digital asset with a different cryptographic address;
wherein the second digital asset is stored on a blockchain;
execute the self-executing computer program,
wherein execution of the self-executing computer program—
transmits the first digital asset to the second platform of the blockchain protocol; and
causes the second platform of the blockchain protocol to transmit the second digital asset to the first platform.

11. The system of claim 9, wherein the instructions when executed by the at least one hardware processor of the system, cause the system to:
execute the self-executing computer program,
wherein the self-executing computer program is a smart contract associated with a smart wallet or a delegation signature associated with an externally-owned account.

12. The system of claim 10, wherein the instructions when executed by the at least one hardware processor of the system, cause the system to:
receive the instructions indicating the first digital asset of the first platform, the second platform of the blockchain protocol, the second digital asset, and a user account; and
execute the self-executing computer program,
wherein execution of the self-executing computer program—
transmits the first digital asset to the second platform of the blockchain protocol; and
causes the second platform of the blockchain protocol to transmit the second digital asset to the user account.

13. The system of claim 9, wherein the second platform of the blockchain protocol further comprises:
a decentralized finance protocol;
a yield earning protocol; or
a decentralized exchange protocol.

14. The system of claim 10, wherein the instructions when executed by the at least one hardware processor of the system, cause the system to:
prior to causing the first platform to transmit the first digital asset to the self-executing computer program, request an access token from the first platform; and
cause, via the access token and the API call to the first platform, the first platform to transmit the first digital asset to the self-executing computer program of the system that is stored on the blockchain.

15. The system of claim 10, wherein the instructions when executed by the at least one hardware processor of the system, cause the system to:
detect, based on a query of data associated with the transmission of the first digital asset to the self-executing computer program, that the self-executing computer program has received the first digital asset; and
in response to detecting that the self-executing computer program has received the first digital asset, transmit the cryptographic key and the instructions to the self-executing computer program.

16. A method comprising:
receiving a cryptographic key that is associated with a user;
receiving instructions indicating a first digital asset of a first platform, a second platform of a blockchain protocol, and a second digital asset,
wherein the first digital asset and the second digital asset are stored on a blockchain;
causing the first platform to transmit the first digital asset to a self-executing computer program that is stored on the blockchain;
in response to receiving the first digital asset at the self-executing computer program, transmit the cryptographic key and the instructions to the self-executing computer program;
execute the self-executing computer program,
wherein execution of the self-executing computer program—
transmits the first digital asset to the second platform of the blockchain protocol; and
causes the second platform of the blockchain protocol to transmit the second digital asset to the first platform.

17. The method of claim 16, wherein the method further comprises:
executing the self-executing computer program,
wherein the self-executing computer program is configured to execute in response to the self-executing computer program receiving (i) the cryptographic key, (ii) the instructions, and (iii) the first digital asset; and
wherein the self-executing computer program is a smart contract associated with a smart wallet or a delegation signature associated with an externally-owned account.

18. The method of claim 16, wherein the method further comprises:
receiving the instructions indicating the first digital asset of the first platform, the second platform of the blockchain protocol, the second digital asset, and a user account; and
executing the self-executing computer program,
wherein execution of the self-executing computer program—
transmits the first digital asset to the second platform of the blockchain protocol; and
causes the second platform of the blockchain protocol to transmit the second digital asset to the user account.

19. The method of claim 16, wherein the method further comprises:
prior to causing the first platform to transmit the first digital asset to the self-executing computer program, requesting an access token from the first platform; and
causing the first platform to transmit the first digital asset to the self-executing computer program that is stored on the blockchain.

20. The method of claim 16, wherein the method further comprises:
detecting, based on a query of data associated with the transmission of the first digital asset to the self-executing computer program, that the self-executing computer program has received the first digital asset; and
in response to detecting that the self-executing computer program has received the first digital asset, transmitting the cryptographic key and the instructions to the self-executing computer program.
